(19) United States
(12) Patent Application Publication
(10) Pub. No.: US 2005/0142047 A1
(43) Pub. Date: Jun. 30, 2005

(54) Hybrid-type air purifier for an automobile

(75) Inventors: Hong Koo Baik, Seoul (KR); Jai Hyuk Choi, Seoul (KR); Jin Ho Park, Seoul (KR)

Correspondence Address: EDWARDS & ANGELL, LLP, P.O. BOX 55874, BOSTON, MA, 02205, US

(73) Assignees: Hyundai Motor Company, Seoul (KR); Kia Motors Corporation, Seoul (KR)

(21) Appl. No.: 11/009,894

(22) Filed: Dec. 8, 2004

(30) Foreign Application Priority Data
Dec. 31, 2003 (KR) 2003-0101969

(51) Int. Cl. B01J 19/08

(52) U.S. Cl. 422/186.04

(57) ABSTRACT

Air purifier systems particularly suitable for motor vehicles are provided that comprise an air flow passage; a glow discharging device; a photo-catalyst device; and a negative ion generator. Preferred air purifiers comprise a glow discharging device having mesh-structured electrodes which can purify air via dielectric barrier discharge, a photo-catalyst device that can further purify the air firstly purified by the glow discharging device, and a negative ion generator having nano tubes, which can treat the purified air with negative ions.

### CROSS REFERENCE TO RELATED APPLICATION

This application is based on, and claims priority from Korean Patent Application No. 2003-101969, filed on Dec. 31, 2003, the disclosure of which is hereby incorporated by reference.

### FIELD OF THE INVENTION

The present invention relates to air purification systems particularly useful for automobiles and other motor vehicles. Preferred air purification systems of the invention comprise a dielectric barrier discharge, photo-catalyst device and negative ion generator.

### BACKGROUND OF THE INVENTION

An air purifier has been provided in the interior of an automobile in order to remove contaminants, germs or unpleasant odors in the air that circulates in a passenger's compartment or flows into the interior from the exterior of the automobile.

Purifying technologies are roughly categorized into several types in accordance with their respective approaches to collection of contaminants and deodorization.

More particularly, there is a conventional air purifier that employs discharge electrodes that generate a corona emission. Negative ions formed via the corona emission ionize contaminants present in treated air and generate a small amount of ozone to sterilize and deodorize the air.

For example, Japanese unexamined patent publication No. 2002-136893 discloses a certain air purifier that contains a housing and a plurality of needle-shaped electrodes for corona discharge, which are furnished within the housing.

As another example, Japanese unexamined patent publication No. 2000-247141 discloses a certain air conditioning system consisting of corona discharging electrodes and a negative-ion generator capable of producing negative ions with low voltage.

As yet another example, Japanese unexamined patent publication No. Hei11-576 discloses a certain air cleaner for an automobile, which is provided with a means for corona discharging between two collecting means.

The accompanied FIG. 2 shows electrodes of a typical air purifier of corona-emission type, wherein a collecting electrode 12 of plate type and a discharge electrode 14 including a plurality of discharging tips 16 are disposed with a certain interval in a housing (not shown). With such an arrangement of the electrodes, negative ions are generated by applying a voltage to the electrodes. The plurality of the discharging tips 16 formed at the front end of the discharge electrode facilitate the generation of the negative ions. When a voltage is applied to the electrodes, electrons having negative electricity are emitted from the discharging tips 16 of the discharge electrode 12 toward the collecting electrode 12 generating negative ions by colliding with molecules of air, so that the molecules are collected at the collecting electrode.

The accompanied FIG. 3 illustrates a conventional air purifier provided with a filter and an ion-generating device, in which a blower (not shown in the figure) intakes air and passes it through a HEPA (high efficiency particulate air) filter 22 so as to scavenge contaminants contained in the air. The air is further purified and sterilized by negative ions generated by the ion-generating device comprising a negative plate 24 and a plurality of ion-generating tips 26. Negative ions can be generally effective in sterilizing germs and dissociating molecules of odors and contaminants in air.

Certain air purifiers utilizing an activated carbon or catalysts such as TiO₂ and MnO₂ also have been reported.

However, the conventional corona emission type air purifier, which is currently the generally most popular system, can be disadvantageous in that a considerable amount of ozone is generated during a purifying process. The ozone inherently has a strong oxidizing power, which is effective in sterilizing and deodorizing with a small amount thereof. However, when the amount of ozone in air exceeds a certain level, it can become harmful to humans. Moreover, a corona emission type air purifier can generate harmful NOₓ gases as byproducts along with the discharge of corona. Furthermore, because the plasma formed by the corona discharge can be non-uniform and unstable, the discharging area can be very limited thus restricting the purification and deodorization effectiveness of the system.

A conventional filter type air purifier can be disadvantageous in that filters require periodic replacement due to contaminants that accumulate in the filters and which can impede optimal air ventilation through the filters. Such filter replacement increases maintenance costs. Moreover, there is a possibility of the proliferation of germs in the filters.

For an air purifier installed and operated in the interior of an automobile, which is a substantially closed area, it is not desirable to use the conventional air purifier systems that can produce harmful ozone or NOₓ gases, and/or propagate of germs.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, the present invention provides a hybrid type air purifier, which comprises a dielectric discharge (DBD) device and can improve the efficiency of removal of contaminants, sterilization of germs, and deodorization.

In another aspect, the present invention provides a hybrid type air purifier, which comprises a photo-catalyst device and can avoid use of potentially harmful ozone.

In a further aspect, the present invention provides a hybrid type air purifier, which comprises a negative ion generator and is capable of effective generation of healthful negative ions.

In particularly preferred embodiments, the present invention provides an air purification system comprising a casing defining an air flow passage, a glow-discharging device having electrodes which can purify air by plasma formed via dielectric barrier discharge (DBD), a glow-discharging device being disposed at a front end of the air flow passage, a photo-catalyst device positioned at the downstream of the glow-discharging device in the air flow passage, and a negative ion generator for forming negative ions in the air passing therethrough by discharging negative electrode material, the negative ion generator being positioned at the downstream of the photo-catalyst device in the air flow passage, adjacent to the rear end of the air flow passage.

The glow-discharging device is preferably configured in such a manner that air freely passes therethrough. When a voltage is applied to the electrodes of the DBD glow-discharging device, plasma is generated via dielectric barrier discharge, by which the air passing the DBD glow-discharging device is purified.

Preferably, the glow-discharging device is configured by superposing a plurality of dielectric units, wherein the dielectric unit is composed of two dielectric barriers disposed parallel with each other between which an air passage is formed and two electrodes connected to the dielectric barriers, respectively.

More preferably, in the superposed dielectric units, the electrodes are interposed between each dielectric unit, having a mesh structure.

Preferably, the photo-catalyst device purifies air by exposure to activating energy such as ultraviolet radiation that is suitably generated during dielectric barrier discharge (DBD) of the glow-discharging device.

It is understood that the term “vehicle” or other similar term as used herein is inclusive of motor vehicles in general such as passenger automobiles, buses, trucks, various commercial vehicles, watercraft, aircraft, and the like.

Other aspects of the invention are discussed below.

### BRIEF DESCRIPTION OF THE DRAWINGS

The aforementioned aspect and other features of the present invention will be explained in the following detailed description, taken in conjunction with the accompanying drawings, wherein:

FIG. 1 is a cross sectional view schematically showing an air purifier for an automobile according to an embodiment of the present invention; and

FIG. 2 is schematic view illustrating a discharging electrode and a collecting electrode of a typical air purifier of corona-emission type according to a prior art.

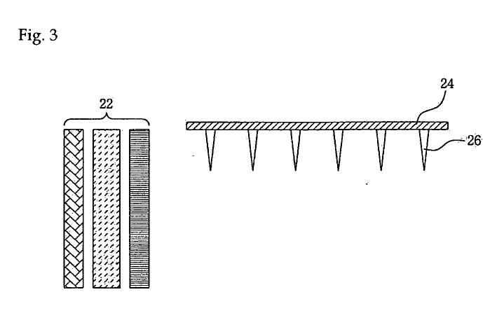

### DETAILED DESCRIPTION OF THE INVENTION

As discussed above, the invention provides air purification systems particularly suitable for motor vehicles such as an automobile. Preferred air purification systems of the invention may comprise an an air flow passage which may be suitably defined by e.g. a casing; a glow discharging device; a photo-catalyst device; and a negative ion generator, wherein the glow discharge device, photo-catalyst device and negative ion generator are all associated with the air flow passage.

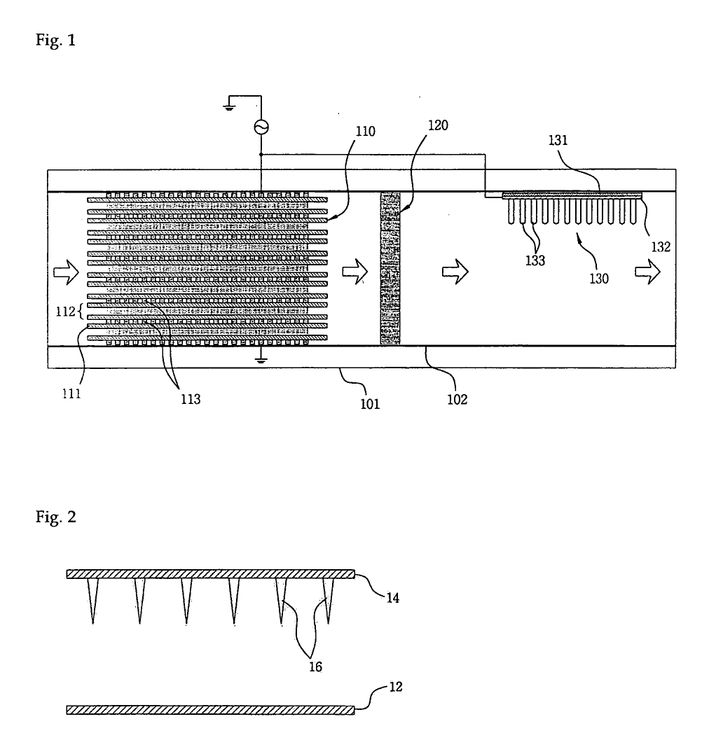

Referring to FIG. 1 showing an air purifier of a preferred embodiment according to the present invention, numerals 110, 120 and 130 indicate a glow-discharging device, a photo-catalyst device, and a negative-ion generator, respectively. The air purifier is provided with a glow-discharging device 110 that is installed adjacent to a frontal end of an air flow passage 102 defined by a casing 101. When voltage is applied to the glow-discharging device 110, the glow-discharging device starts to collect contaminants, sterilize and/or deodorize the air. The glow-discharging device 110 generates activated species, negative ions and ultraviolet rays via dielectric barrier discharge so as to purify air.

In a preferred embodiment, the glow-discharging device 110 is accomplished by superposing a plurality of dielectric units 112, wherein each dielectric unit 112 is composed of two dielectric barriers 111 disposed parallel with each other between which an air passage is formed, and two electrodes 113 connected to the dielectric barriers, respectively. The dielectric barrier 111 is suitably made of an insulating material. More preferably, the dielectric barrier 111 is made of one or more ceramics such as alumina and/or quartz.

In the superposed dielectric units, the electrodes 113 are interposed between two dielectric units, each of which having a mesh structure with a regular space. The electrodes 113 made of conductive materials, such as copper, aluminum or stainless steel are electrically connected to an external power supply 200. In the preferred embodiment, the electrodes 113 interposed between the dielectric units are electrically connected to each other by a connecting line (not shown in the accompanied drawings).

Because of the geometry of the mesh-structured electrodes, the glow discharging device 110 employing the electrodes of the mesh structure is able to efficiently and stably discharge. That is, when voltage is applied to the mesh-structured electrodes 113 so as to generate plasma, the density of electrons are uniformly distributed which can facilitate the formation of plasma.

Compared with a conventional corona discharge, preferred glow discharge employed in preferred systems of the invention can generate greater amounts of ozone and ultraviolet radiation. Accordingly, preferred DBD devices of systems of the invention can be superior to the conventional corona discharging system in removal of contaminants.

The mesh-structured electrodes 113 according to a preferred embodiment of the present invention are able to freely adjust the size thereof in order to increase the volume of plasma while ensuring the stable formation of plasma. Consequently, it is possible to provide an efficient air purifier having a large capacity, which can enable treatment of a large amount of air with minimum consumption of energy.

The dielectric barrier discharge (DBD) of the glow discharging device according to preferred systems of the invention emits ultraviolet radiation that is used in sterilizing the air together with a photo-catalyst device 120.

In a preferred embodiment, in an air flow passage 102, a photo-catalyst device 120 is provided, which is located at the downstream of the glow discharging device 110. Therefore, the air introduced into the air flow passage passes through the dielectric units 111 of the glow discharging device 110 and is subsequently supplied to the photo-catalyst device 120. The photo-catalyst device 120 may suitably comprise a photo-catalyst (e.g. a semiconductor material such as titania, ZnO, etc.) coated onto the surface of a carrier material such a honeycomb structure.

In use, a photo-catalyst device 120 which may comprise a photocatalyst material such as e.g. TiO₂ coated on a substrate of the photo-catalyst device 120 is exposed to activating radiation particularly ultraviolet radiation whereby product(s) having oxidizing power can be generated. Those generated oxidants can interact with harmful or otherwise undesirable materials in contaminated air to thereby render those undesirable materials harmless or otherwise decontaminated.

Preferred systems of the invention may further comprise a negative ion generator 130 which is suitably located downstream of the photo-catalyst device 120 in the air flow passage 102. The negative ion generator 130 suitably comprises a conductive layer 132 and a plurality of nano tubes 133 installed on the conductive layer 132.

In the negative ion generator 130, the nano tubes 133 can serve as negative-ion tips. In a preferred embodiment, the negative ion generator may be provided by growing the nano tubes 133 on a conductive layer, for example a metal layer, disposed on a substrate layer 131 via chemical vapor deposition (CVD) or a printing method.

When a cathode of a power supply is connected to the nano tubes 133 of the negative ion generator, the nano tubes 133 generate negative ions via electric discharge. The utilization of nano tubes 133 in generating negative ions can significantly increase the amount of negative ions. Even where the voltage applied to the nano tubes 133 is low, electric discharge can still be possible. Moreover, the ion generating rate per unit area is considerable compared with a conventional ion generator.

Thus, as discussed, particularly preferred air purifier systems of the present invention include a glow discharging device 110 having mesh-structured electrodes which can purify air via dielectric barrier discharge when voltage is applied thereto, a photo-catalyst device 120 that can further purify the air firstly purified by the glow discharging device 110, and the negative ion generator 130 having nano tubes 133, which can provide the purified air with negative ions. Preferred air purifier systems of the invention are particularly adapted for use in automobiles and other motor vehicles.

All documents mentioned herein are incorporated herein by reference in their entirety.

Even though the present invention is described in detail with reference to the foregoing embodiments, it is not intended to limit the scope of the present invention thereto. It is evident from the foregoing that many variations and modifications may be made by a person having an ordinary skill in the present field without departing from the essential concept of the present invention.

1. An air purifier comprising:
a casing defining an air flow passage;
a glow discharging device having electrodes, which can purify air by plasma formed via dielectric barrier discharge, the glow discharging device being disposed at a front end of the air flow passage;
a photo-catalyst device positioned at the downstream of the glow-discharging device in the air flow passage, which can further purify the air firstly purified by the glow discharging device; and
a negative ion generator for forming a negative ions in the air passing therethrough by discharging negative electrode material, the negative ion generator being positioned at the downstream of the photo-catalyst device in the air flow passage, adjacent to the rear end of the air flow passage.

2. The air purifier according to claim 1, wherein the glow discharging device is constructed by superposing a plurality of dielectric units, wherein the dielectric unit is composed of two dielectric barriers disposed parallel with each other between which an air passage is formed and two electrodes connected to the dielectric barriers, respectively.

3. The air purifier according to claim 2, wherein the electrodes are interposed between two dielectric units and have a mesh structure with a regular arrangement.

4. The air purifier according to claim 1, wherein the photo-catalyst device purifies air by utilizing ultraviolet ray generated during dielectric barrier discharge of the glow-discharging device.

5. An air purifier comprising:
an air flow passage;
a glow discharging device electrodes;
a photo-catalyst device; and
a negative ion generator.

6. A motor vehicle comprising an air purifier of claim 5.
